(19) United States
(12) Patent Application Publication
(10) Pub. No.: US 2012/0116942 A1
(43) Pub. Date: May 10, 2012

(54) COMPUTER SYSTEM AND METHOD FOR GENERATING AND EXECUTING ORDERS WITHIN A PRICE RANGE

(75) Inventor: Christian VOIGT, London (GB)

(73) Assignee: Deutsche Boerse AG

(21) Appl. No.: 12/940,418

(22) Filed: Nov. 5, 2010

(51) Int. Cl. G06Q 40/00

(52) U.S. Cl. 705/37

(57) ABSTRACT

A computer system and method generate orders to be executed in an electronic exchange, and execute the orders. An order data processor processes order data, and an order transmitter transmits an order to the electronic exchange based thereon. The order data includes at least one price limit which specifies a range of prices that is required for the order to be executed. The order is executable within the price range only. If the order is a buy order, the at least one price limit includes a minimum price to execute the buy order, and if the order is a sell order, the at least one price limit includes a maximum price to execute the sell order. The order is added to an order book for being executed at the end of a call auction. A derivatives trader may thus reduce the risk of having incorrect inventory in an underlier.

The invention relates to computer systems and methods for generating orders to be executed in an electronic exchange and to computer systems and methods for executing orders in an electronic exchange. The computer systems enable a derivatives trader, who trades at the electronic exchange, to reduce the risk of having an incorrect inventory in an underlier, e.g. stocks or other instruments that are the basis for the derivative.

Electronic exchanges for trading equities, such as stocks, and other financial instruments exist, such as Xetra or Eurex. Such exchanges allow traders to place orders to trade different order types in different trading sessions of the electronic exchange. For instance, a trader may place a market order or a limit order to buy or sell a single stock in a closing call auction or during continuous trading. In doing so, traders can define a maximum buy price limit or a minimum sell price limit to ensure that the trader will not trade at a price which is worse than desired. If the price is better than the set limit, i.e., it does not exceed the maximum buy price limit and does not fall below the minimum sell price limit, then the order will be executed. Depending on the type of call auction, the order will be executed immediately, or will be held until the end of a scheduled closing call auction.

Derivatives traders may face the pin risk if they hold an option (or a portfolio of multiple options) at the expiration and follow a delta neutral strategy. On expiry date, if the option is very close at the money (ATM), then it has a very high gamma. As is well known in the art, the term “gamma” refers to the change in delta for a move in the underlier. Furthermore, the delta refers to the change in the value of the option for a move in the underlier. Thus, ATM options are extremely sensitive to movements in their underlying stock. This may likewise be valid for other types of derivatives. The pin risk describes the risk that the derivatives trader ends up with an incorrect delta neutral hedging position due to rapid changes in delta and gamma.

The following example illustrates how the pin risk emerges. Let's assume a derivatives trader at Eurex that does the hedging trades at Xetra. The derivatives trader holds an option portfolio consisting of one short call. If this trader is hedging the delta, the trader should either have zero shares if the settlement price is below the strike price or be long a certain number of shares per contract if the price is above the strike price. The trader cannot provide the exchange a set of pre-defined conditional orders that would allow him to execute the strategy. Therefore, the trader has to monitor the market and send orders depending on the market changes. There is a risk that the derivatives trader ends up with incorrect inventory in the underlying, due to that monitoring process. For many traders it is important to have the correct delta neutral position conditional on the closing call auction price of the underlier of the option.

To avoid or at least reduce this pin risk, traders may want to observe the indicative prices of the closing call auction and adjust their orders whenever the indicative prices cross the strike price. However, if an indicative price crosses the strike price during a random end of the call phase, there is still a risk that the trader cannot update the orders before the call phase of the call auction is ended. Thus, traders might still end up with the wrong inventory in the underlier because of such latency-related problems.

Moreover, traders who constantly update their orders will likely not be able to receive full allocation of their orders. This is because the time stamp of an order is used to determine the allocation of orders if too many shares are available at a specific price level.

Finally, traders are usually active in many different options and corresponding underlying equities. Thus, traders have to follow the closing call auctions of several equity instruments in parallel. Due to the random end of the call auctions, traders cannot even predict when the closing call auctions will end and which closing call auction will be closed earlier than other call auctions. This scheduling problem increases the complexity of monitoring and adjusting orders.

### SUMMARY

Given these drawbacks in the prior art systems, embodiments are provided to avoid or at least reduce pin risk, to ensure that regardless of the closing action price, traders will always have the correct number of stocks traded. The embodiments may further minimize the allocation risk, i.e., the risk to not receive full allocation of their orders.

A computer system is provided for generating orders to be executed in an electronic exchange. The computer system comprises an order data processor configured to process order data received from a trader, and an order transmitter configured to transmit an order to the electronic exchange based on the order data. The order data processor is configured to process order data that includes at least one price limit which specifies a range of prices that is required for the order to be executed. The order transmitter is configured to transmit an order that is executable within the price range only. If the order is a buy order, the at least one price limit includes a minimum price to execute the buy order, and if the order is a sell order, the at least one price limit includes a maximum price to execute the sell order.

There is also provided a computer system for executing orders in an electronic exchange that has one or more call auctions. The computer system comprises an order receiver configured to receive an order to be executed. The order indicates a lower price limit and an upper price limit. The computer system further comprises a processor coupled to the order receiver and configured to add the order to an order book of the electronic exchange for being executed at the end of at least one of the call auctions. The order is not executed if the call auction price determined at the end of the call auction is below the lower price limit or above the upper price limit.

Moreover, a computer-implemented method for a derivatives trader trading at an electronic exchange is provided to reduce the risk of having incorrect inventory in an underlier. The electronic exchange is caused to write data into a data storage memory of a computer system of the electronic exchange, where the data storage memory represents an order book. The data indicates characteristics of an order to buy or sell the underlier. The characteristics comprise a minimum buy price or a maximum sell price.

### BRIEF DESCRIPTION OF THE DRAWINGS

The accompanying drawings are incorporated into and form a part of the specification for the purpose of explaining the principles of the embodiments. The drawings are not to be construed as limiting the invention to only the illustrated and described examples of how the invention can be made and used. Further features and advantages will become apparent from the following and more particular description of the embodiments, as illustrated in the accompanying drawings, wherein:

FIG. 1a is a block diagram illustrating an environment for use with an electronic exchange in accordance with an embodiment;

FIG. 1b illustrates a front-end computer system according to an embodiment, which may be used in the environment of FIG. 1a;

FIG. 1c illustrates a back-end computer system according to an embodiment, which may be used in the environment of FIG. 1a;

FIG. 2 is a flow chart illustrating how traders may want to reduce the pin risk by using existing limit orders during a closing call auction;

FIG. 3 is a flow chart illustrating how traders can avoid or reduce the pin risk in accordance with an embodiment;

FIG. 4a provides an example of calculating the cumulated buy volume of limit orders;

FIG. 4b illustrates an example of calculating the cumulated buy volume of orders in accordance with an embodiment; and

FIG. 5 is a flow chart illustrating a price determination process according to an embodiment.

### DETAILED DESCRIPTION

The illustrative embodiments will be described with reference to the figure drawings wherein like elements and structures are indicated by like reference numbers.

As will be described in the following in more detail, embodiments provide computer systems and methods for generating orders that specify a range of prices required for the order to be executed, and/or a minimum buy price or a maximum sell price.

In the following, these orders will be referred to as “strike match” orders, and the computer systems of the embodiments may use these types of orders in addition to any conventional order types.

In an embodiment, a strike match order is an order type having two limits. The first limit may be considered to be identical with the limit of a limit order or market order. The second limit allows defining a minimum price for a buy order or a maximum price for a sell order.

| | | Price Limit 1 | Price Limit 2 |
|---|---|---|---|
| | | . . . order is | . . . order is |
| Order | Trade | executable as | executable as |
| Type | Direction | long as . . . | long as . . . |
| Market | Buy | Call Auction Price ≦ ∞ | n.a. |
| Market | Sell | Call Auction Price ≧ 0 | n.a. |
| Limit | Buy | Call Auction Price ≦ | n.a. |
| | | Limit 1 | |
| Limit | Sell | Call Auction Price ≧ | n.a. |
| | | Limit 1 | |
| Strike | Buy | Call Auction Price ≦ | Call Auction Price ≧ |
| Match | | Limit 1 | Limit 2 |
| Strike | Sell | Call Auction Price ≧ | Call Auction Price ≦ |
| Match | | Limit 1 | Limit 2 |

When comparing these order types, one can see that the conventional orders, i.e., the market orders and limit orders, have exactly one price limit to specify when the order is to be executed. Furthermore, the market order is just a special case of a limit order. A market order has a price limit of infinity or zero, depending on the trade direction. By contrast, a strike match order enables the traders to define a range of prices in which they are willing to trade. Thus, in the embodiments, traders may place strike match orders in addition to or as an alternative to market orders and limit orders, to ensure that a buy order is not executed if the call auction price is equal to or above the minimum buy limit, and a sell order is not executed if the call auction price is equal to or below the maximum sell limit. Furthermore, it is possible to define a strike match order where Price Limit 1 equals zero or infinite, similar to a market order. The difference between a market order and a strike match order, would be the use of Price Limit 2.

Thus, the embodiments no longer assume that traders are willing to trade for any better price than the maximum buy price or the minimum sell price. Rather, embodiments are provided based on the finding that traders may want to buy as soon as the price is above a certain level (strike price). This allows a trader to condition its trading behavior on a new parameter.

In an embodiment, the strike match order is used predominantly to reduce or avoid the pin risk for derivatives with physical delivery. This may be the case for single stock options at an electronic exchange. Nevertheless, while embodiments make use of the strike match order to reduce or avoid the pin risk for single stock options with physical delivery, it is noted that strike match orders may be employed in other areas as well.

By means of strike match orders, traders are able to enter a full schedule of order into the call auction to ensure that they always have the correct number of stocks traded, regardless of the closing call auction price. In addition, the allocation risk is minimized because traders can enter the strike match orders much earlier and receive an order time stamp.

Moreover, the strike match order may free some capacity of traders because the traders are not forced to monitor the closing call auction and update its orders. With the strike match order, traders have the possibility to enter a schedule of orders which provides them with the appropriate executed volume, depending on the closing call auction price.

In an embodiment, the strike match order is applicable to any call auction. Thus, the strike match order may be employed in the intraday call auction and closing call auction of all stocks which are an underlier at the electronic exchange. In an embodiment, the strike match order is implemented for all stocks of the exchange.

It is noted that the strike match order may substantially decrease the implementation costs for a delta neutral trading strategy. This effect represents a decrease in overall transaction costs.

The strike match order may allow managing the cash leg of delta neutral trading strategies more efficiently. Inventory adjustments of the cash leg in a delta neutral trading strategy may take place continuously. Thus, traders may use the strike match order every day to adjust the holdings in the underlying equities during a call auction. It is however noted that risks may become most relevant on the settlement day of the derivatives positions.

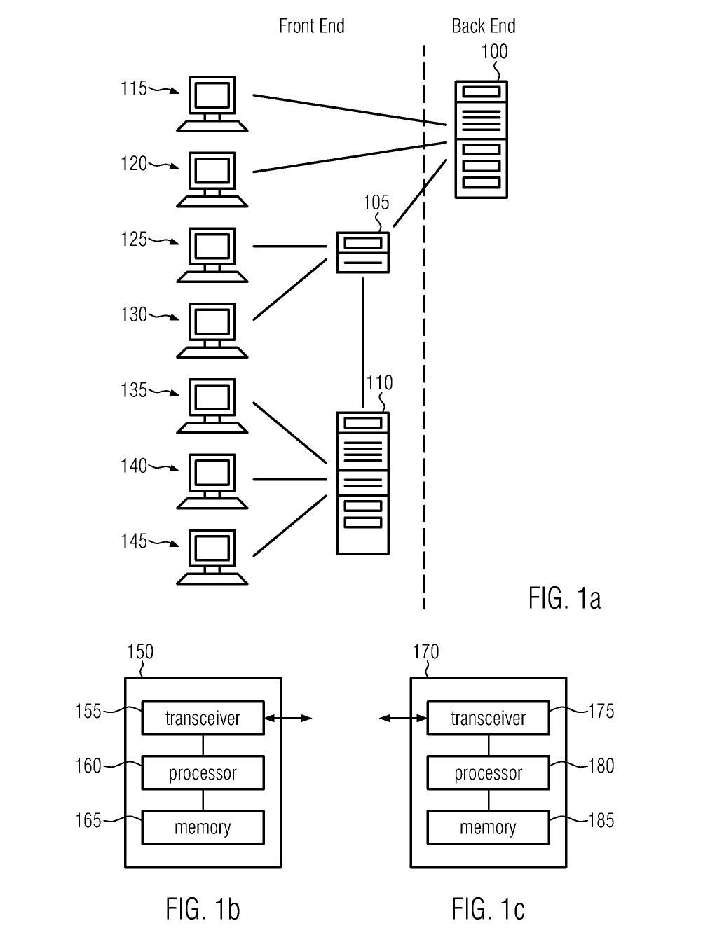

Turning now to the drawings, and in particular to FIG. 1a, a trading environment is depicted in accordance with an embodiment. In this architecture, there is at least one back-end computer system 100 which can be regarded as the central entity of the exchange. The back-end computer system 100 includes one or more order books stored in a memory device and has all the logic implemented by a processor, such as a general purpose computer programmed in a particular manner, to run the electronic exchange.

The back-end computer system 100 may be physically implemented by means of a single computer system, or may be built from a number of several distinct computer systems that work together to run the electronic exchange.

As apparent from FIG. 1a, the back-end computer system 100 is connected to number of front-end computer systems 115-145. These front-end computer systems may be used by traders to enter order data which are then transmitted to the back-end computer system 100. The back-end computer system 100 may also send data back to the front-end computer systems 115-145, for instance to provide order confirmations or send prices.

As can be further seen from FIG. 1a, there may be additional entities in the path between the back-end computer system 100 and the front-end computer systems 115-145. For instance, there may be one or more access points 105 and optionally, one or more additional servers 110. Examples of such servers are MISS (Member Integration System Server) units. Although FIG. 1a depicts the access point 105 and additional servers 110 to be located on the front-end side of the architecture, it is appreciated that other embodiments exist in which one or more access points 105 or one or more of the additional servers 110, or both, are located on the back-end side.

Referring now to FIG. 1b, a sample structure of a front-end computer system 115-145 is depicted. This structure 150, which may be included in any of the front-end computer systems shown in FIG. 1a, includes a transceiver 155 to transmit and receive order data and responses. In an embodiment, the transceiver 155 may include separate units for transmitting and receiving. Thus, the transceiver 155 may be regarded to be or include an order transmitter to transmit an order to the electronic change.

The front-end computer system structure 150 of FIG. 1b further includes a processor to process order data received from a trader. In addition, there may be a memory 165 to store all the data received from the trader. The memory may also store confirmation responses and prices. The front-end computer system 150 may consist of, for example, a personal computer.

In FIG. 1c, an exemplary structure 170 of the one or more back-end computer systems 100 of FIG. 1a is depicted. The structure 170 of the depicted embodiment includes a transceiver 175 to receive orders from the front-end side and send back confirmation messages and prices. The transceiver 175 may be embodied by means of separate transmission and reception units. Thus, the transceiver 175 may be regarded as order receiver that receives an order to be executed.

The back-end computer system structure 170 further comprises a processor 180 that receives order data from the transceiver section 175 and adds the order to an order book of the electronic exchange.

Further, the structure 170 includes a data storage memory 185 to store order data and/or prices. In an embodiment, the memory 185 stores an order book. The back-end computer system may consist of, for example, one or more server computers.

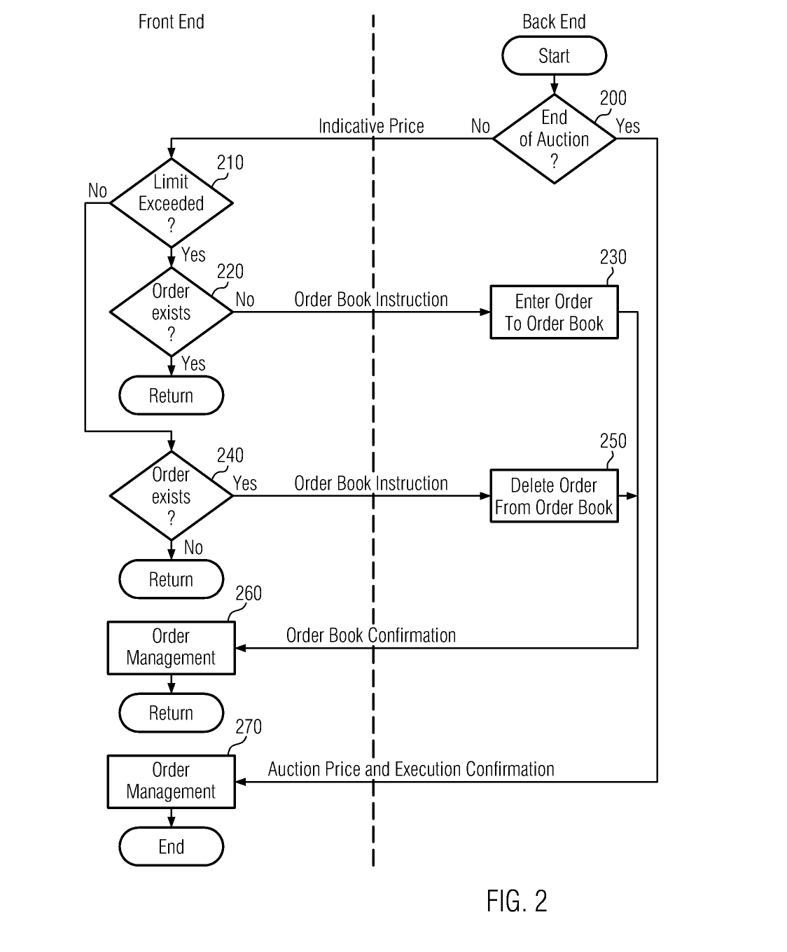

As described above, when a derivatives trader wants to mitigate pin risk using conventional limit orders, then the trader may face a number of problems. This will now be explained in more detail with reference to FIG. 2, assuming that the trader operates in the architecture illustrated in FIGS. 1a to 1c. It is, however, noted that the same or similar problem may occur in other environments as well.

Referring to FIG. 2, it may be assumed that a trader follows a delta neutral hedging strategy with limit or market orders, and that a trader needs to buy, for example, one hundred shares of the stock if the price is greater than or equal to a certain price limit, e.g., 65.00 EUR. As long as the call auction is ongoing, the process determines in step 200 that the call auction has not yet come to an end. Therefore, the back-end computer system 100 sends out an indicative price to the trader's front-end computer system 115-145.

The trader front end computer system checks every incoming indicative price in step 210 to determine if the indicative price is greater than or equal to the limit, i.e., 65.00 EUR. In addition, it checks in steps 220 or 240 whether the trader currently has an order entered in the order book. If the trader front-end determines that the limit is exceeded and that an order exists, the process returns to again proceed with step 200. If the limit is exceeded but no corresponding order exists, the trader may decide to enter a new order. The back-end computer system 100 will then enter the order to the electronic exchange's order book in step 230 in accordance with the instructions received from the front-end side. Then, the trader receives a confirmation of the entered order in step 260.

If it is determined in step 210 that the limit is not exceeded, and where it is then further determined in step 240 that an order exists in the order book, a trader has the opportunity to delete the order in the order book. If the trader decides to do so, he sends a respective order book instruction to the back-end side so that the back-end computer system 100 can proceed to delete the order from the order book in step 250. Again, the trader receives a confirmation of the deleted order in step 260.

As apparent from FIG. 2, the process runs through a loop as long as the call auction is ongoing. However, when the back-end computing system 100 determines in step 200 that the call auction has ended, it determines the call auction price and sends out this price to the front-end. The trader is informed in step 270, i.e. after the call auction, that the order was executed and at which price. If the order could not be executed at the end of the call auction, the trader will likewise be informed accordingly in step 270.

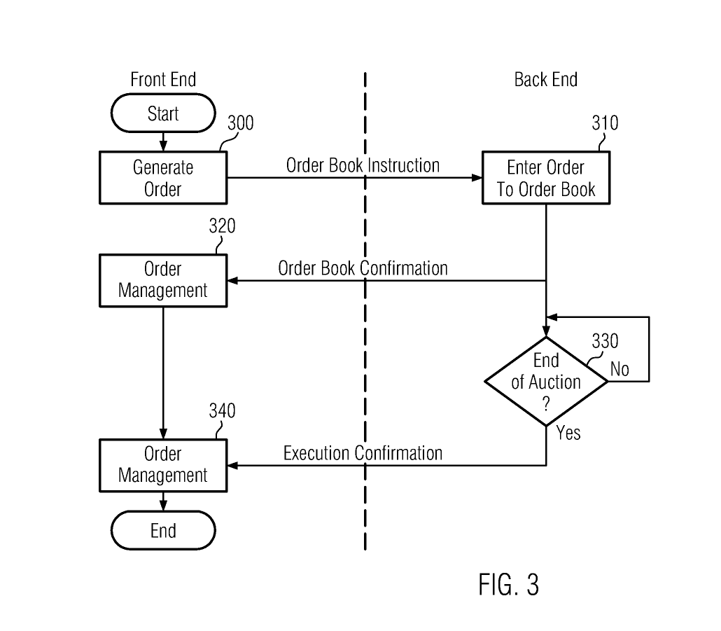

While FIG. 2 depicts a process which a trader can perform in the environment of FIGS. 1a to 1c when using conventional orders, FIG. 3 depicts a corresponding process when making use of a strike match order in an embodiment. In step 300, the trader generates a strike match order and instructs the back-end computer system 100 to enter the order to the order book in step 310. The trader then receives a confirmation in step 320.

As long as the call auction ongoing, the process waits in step 330 without producing further traffic on the network. When the call auction stops, the back-end computer system 100 confirms to the front-end side whether the order could be executed and at which price. Thus, the trader receives in step 340 the respective information after termination of the call auction.

When comparing FIG. 3 with FIG. 2, it is readily apparent that the traffic on the physical lines of the network is drastically reduced as the multiple loops in FIG. 2 are not carried out. Thus, by giving more detailed instructions to the back end via strike match orders in contrast to market orders or limit orders, the trader front end does not need to perform a continuous updating process. This reduces the amount of traffic on the physical lines of the network between back end and front end.

Further, as most of the tasks are performed at the back-end side, front-end computer systems performing the process of FIG. 3 may have reduced hardware requirements as compared with front-end computer systems that perform the process of FIG. 2. In addition, the back end may perform those tasks more efficiently because of economies of scales. Therefore, the disclosed embodiments reduce the need for computing resources and provide a more efficient machine for transactions.

As mentioned above, a strike match order makes it unnecessary to constantly monitor and update the orders during the call phase. Thus, the embodiments advantageously decrease the volatility of indicative prices. Moreover, the statistical noise in indicative prices due to order adjustments is reduced. By that, indicative prices and the final call auction price become more informative.

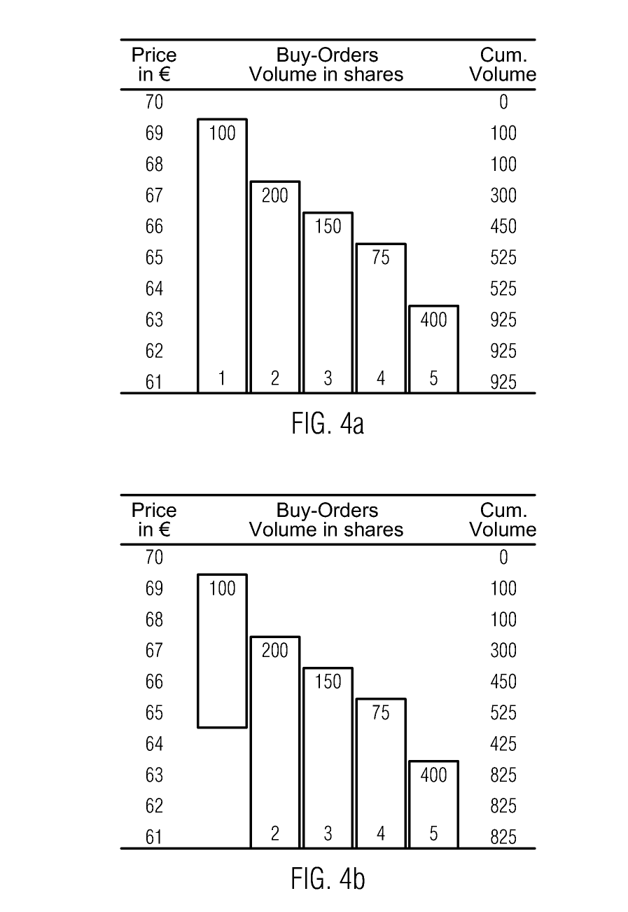

Referring now to FIGS. 4a and 4b, examples are provided of how strike match orders may have an impact on the matching process during a call auction. In an embodiment, two vectors are constantly calculated during a call auction. One vector is the cumulated buy volume and the second vector is the cumulated sell volume, which both depend on the executing price.

Referring first to FIG. 4a, an example is provided in which five limit orders are in the order book. The limit orders have different volumes and different executing prices. The cumulated volume is shown in the rightmost column, and one can see that the cumulated volume is monotonically decreasing depending on the execution price. In other words, the cumulated volume at a higher price cannot be greater than the cumulated volume at a lower price. This is because FIG. 4a relates to an example of limit buy orders. For limit sell orders, the cumulated volume would be monotonically increasing with the execution price.

Turning now to the example of FIG. 4b, there are again five buy orders in much the same way as in the example of FIG. 4a, but the first buy order is now a strike match order having a minimum price of 65.00 EUR. As can be seen from the rightmost column in FIG. 4b, the cumulated volume is no longer monotonically depending on the executing price but has a local maximum at 65.00 EUR and a local minimum at 64.00 EUR. Consequently, in contrast to the example discussed before, the use of at least one strike match order may result in a situation in which the highest cumulated buy and/or sell volumes do not correspond to the lowest surplus.

Thus, placing strike match orders may have an impact on the estimation of the vectors for cumulated volumes, but once the cumulated volume vectors are estimated, the matching process may go on like in conventional systems. In an embodiment, the use of strike match orders does not influence the priority of an order in the matching process during the call auction. Further, the strike match order may constantly remain in the order book and will not be entered in the book once it reaches a trigger point (as this is, for instance, known to be for stop orders).

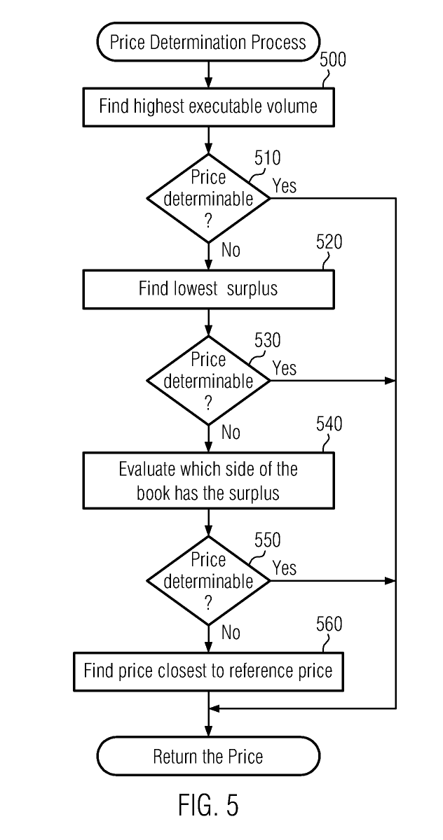

As the placement of strike match orders may break the monotonically dependent relationship between the cumulated volume and the execution price, an embodiment provides a price determination process that takes the execution volume and the surplus as separate criteria. An example of the price determination process according to an embodiment is depicted in the flow chart of FIG. 5. The process can be carried out by the computer systems described above.

In a first step 500, the price determination process finds the highest executable volume and then tries to find out in step 510 whether this information is sufficient for determining the price. If it is not, a second criterion is applied in step 520 by finding the lowest surplus. Again, it is checked in step 530 if a price can now be determined. If the information is still insufficient, step 540 evaluates a third criterion by evaluating which side of the book has the surplus. Again, a check is made in step 550 to see if the price can be determined. If a price can still not be determined, the price determination process performs step 560 to find the price which is closest to the reference price.

It is noted that other embodiments exist in which the order of checking the criteria in the price determination process is different. Moreover, some of the criteria may be dropped or replaced with other criteria in further embodiments. Furthermore, a number of additional criteria may be added to the price determination process of any embodiment. For instance, when there is still an ambiguity after applying all the available criteria, there may be an additional step of rounding up or down the prices. To give an example, if there are two closest prices after performing step 560 in FIG. 5, then the process may select the higher price.

In the following, some matching examples are provided to illustrate potential price determination scenarios. In these examples, the tick size has been chosen to be 1.00 EUR for reasons of simplicity.

In the following table, a first scenario is illustrated in which one market buy order and two strike match sell orders have been input. The quantity of the buy order is 200, and the quantities of the sell orders are 100 each. The strike match sell orders have different minimum and maximum limits. The reference price is 203.

| | Min | Max | | Trade |
|---|---|---|---|---|
| Order Type | Limit | Limit | Quantity | Direction |
| Market | 0 | ∞ | 200 | Buy |
| Strike Match | 208 | 205 | 100 | Sell |
| Strike Match | 203 | 201 | 100 | Sell |
| Ref. Price | | 203 | | |

The resulting order book situation is depicted in the following table.

| Buy | | Call | Sell | | Max | |
|---|---|---|---|---|---|---|
| Cum. | | Auction | | Cum. | Exec | Lowest |
| Quantity | Surplus | Price | Surplus | Quantity | Volume | Surplus |
| 200 | 100 | 208 | 0 | 100 | 100 | 100 |
| 200 | 100 | 207 | 0 | 100 | 100 | 100 |
| 200 | 100 | 206 | 0 | 100 | 100 | 100 |
| 200 | 100 | 205 | 0 | 100 | 100 | 100 |
| 200 | 200 | 204 | 0 | 0 | 0 | 200 |
| 200 | 100 | 203 | 0 | 100 | 100 | 100 |
| 200 | 100 | 202 | 0 | 100 | 100 | 100 |
| 200 | 100 | 201 | 0 | 100 | 100 | 100 |

At a call auction price of 201, the second strike match sell order can be matched against half of the marked buy orders. Accordingly, the maximum execution volume is 100 and the surplus is 100. All price levels except 204 have a maximum executable volume of 100 shares. The price level of 204 has a maximum execution volume of zero because there are no sell orders available. The surplus is always on the demand side. Thus, after performing steps 500, 520 and 540 of FIG. 5, a price can still not be determined in step 550. Given the reference price of 203, step 560 therefore determines 203 in step 560 as the call auction price.

Turning now to a different scenario, there are two strike match sell orders and two strike match buy orders. The quantities and minimum and maximum limits are indicated in the following table.

| | Min | Max | | Trade |
|---|---|---|---|---|
| Order Type | Limit | Limit | Quantity | Direction |
| Strike Match | 198 | 198 | 100 | Sell |
| Strike Match | 198 | 198 | 200 | Buy |
| Strike Match | 202 | 202 | 100 | Buy |
| Strike Match | 202 | 202 | 200 | Sell |
| Ref. Price | | 201 | | |

This results in the following order book situation:

| Buy | | Call | Sell | | Max | |
|---|---|---|---|---|---|---|
| Cum. | | Auction | | Cum. | Exec | Lowest |
| Quantity | Surplus | Price | Surplus | Quantity | Volume | Surplus |
| 100 | 0 | 202 | 100 | 200 | 100 | 100 |
| 0 | 0 | 201 | 0 | 0 | 0 | 0 |
| 0 | 0 | 200 | 0 | 0 | 0 | 0 |
| 0 | 0 | 199 | 0 | 0 | 0 | 0 |
| 200 | 100 | 198 | 0 | 100 | 100 | 100 |

As can be seen, the highest executable volume has call auction prices of 202 or 198. Both price levels have the same surplus, and this surplus is on the supply and demand side, respectively. Thus, the reference price must again be used to determine the auction price. As the auction level of 202 is closer to the reference price than the auction price of 198, the price determination process results in the value of 202.

As noted above, it can be seen from this example that the maximum executable volume does not necessarily have to go along with the lowest surplus. This is because the surplus is lower at call auction prices 201 to 199. The fact that the maximum executable volume does not necessarily have to go along with the lowest surplus is caused by using strike match orders.

The following example scenario differs from the previous scenario in nothing but the reference price. In this example, the reference price is 200.

| | Min | Max | | Trade |
|---|---|---|---|---|
| Order Type | Limit | Limit | Quantity | Direction |
| Strike Match | 198 | 198 | 100 | Sell |
| Strike Match | 198 | 198 | 200 | Buy |
| Strike Match | 202 | 202 | 100 | Buy |
| Strike Match | 202 | 202 | 200 | Sell |
| Ref. Price | | 200 | | |

As apparent from the following order book situation, the highest executable volume is again at call auction prices 202 and 198. Both prices again have the same surplus on the supply and demand side, respectively. However, the reference price is now exactly in the middle of both feasible call auction prices. As mentioned above, in such scenarios the call auction price may be rounded up. Accordingly, the call auction price determined in the present scenario is 202.

| Buy | | Call | Sell | | Max | |
|---|---|---|---|---|---|---|
| Cum. | | Auction | | Cum. | Exec | Lowest |
| Quantity | Surplus | Price | Surplus | Quantity | Volume | Surplus |
| 100 | 0 | 202 | 100 | 200 | 100 | 100 |
| 0 | 0 | 201 | 0 | 0 | 0 | 0 |
| 0 | 0 | 200 | 0 | 0 | 0 | 0 |
| 0 | 0 | 199 | 0 | 0 | 0 | 0 |
| 200 | 100 | 198 | 0 | 100 | 100 | 100 |

After the call auction price is determined, the allocation of executable shares has to be calculated. In the example above, there are 100 shares willing to buy at a price of 202 but 200 shares willing to sell. Thus, 100 shares willing to be sold will not be executed, even though they could.

All sell orders will be sorted according to two different criteria. Firstly orders are sorted according to order type. Market orders gain preference over limit orders. Secondly, orders are sorted according to their order entry time stamps. Older orders gain priority over younger orders. If Price Limit 1 is infinite at a buy strike match order, or Price Limit 1 is zero at a sell strike match order, then the strike match order is treated like a market order in the prioritizing process. In any other case, the strike match order is treated like a limit order.

The embodiments can be implemented by various computing devices arranged in various manners. The devices can be programmed to carry out the functions described herein and to constitute a particular machine. The described functional can be modules of software code executed on appropriate computer hardware. The modules, while segregated by function, need not be discrete portions of code.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. For instance, while the embodiments have been described in price units of EUR, the embodiments are likewise applicable to any other currency, in particular to USD.

In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the spirit and scope of the appended claims.

What is claimed is:

1. A computer system for generating orders to be executed in an electronic exchange, comprising:
an order data processor configured to process order data received from a trader; and
an order transmitter configured to transmit an order to the electronic exchange based on said order data,
wherein the order data processor is configured to process order data that includes at least one price limit specifying a range of prices required for the order to be executed, and the order transmitter is configured to transmit an order that is executable within the price range only, and
wherein, if the order is a buy order, said at least one price limit includes a minimum price to execute the buy order, and if the order is a sell order, said at least one price limit includes a maximum price to execute the sell order.

2. The computer system as recited in claim 1 wherein, if the order is a buy order, said at least one price limit further includes a maximum price to execute the buy order, and if the order is a sell order, said at least one price limit further includes a minimum price to execute the sell order.

3. The computer system as recited in claim 2 wherein the maximum price to execute the buy order is infinite, and the minimum price to execute the sell order is zero.

4. The computer system as recited in claim 1 wherein said at least one price limit is a single price limit, and the price range specified by said single price limit includes all prices above said single price limit in case of a buy order, and all prices below said single price limit in case of a sell order.

5. The computer system as recited in claim 1 wherein the order transmitter is further configured to transmit the order to the electronic exchange for being executed at the end of one of an opening call auction, an intraday call auction and a closing call auction.

6. The computer system as recited in claim 1 wherein the order transmitter is further configured to transmit the order to the electronic exchange only during a trading phase of the electronic exchange.

7. A computer system for executing orders in an electronic exchange having one or more call auctions, comprising:
an order receiver configured to receive an order to be executed, said order indicating a lower price limit and an upper price limit; and
a processor coupled to said order receiver and configured to add the order to an order book of the electronic exchange for being executed at the end of at least one of said call auctions,
wherein the order is not executed if the call auction price determined at the end of the call auction is below said lower price limit or above said upper price limit.

8. The computer system as recited in claim 7 wherein said one or more call auctions comprise one of an opening call auction, an intraday call auction and a closing call auction.

9. The computer system as recited in claim 7 wherein the processor is further configured to delete the order at the end of the call auction if the order is not executed.

10. The computer system as recited in claim 7 wherein the order receiver is further configured to receive orders of different order types including market orders and limit orders, and the processor is further configured to sort the received orders according to their order type,
wherein, when a received order indicates a lower price limit and an upper price limit where the upper price limit is infinite and where the order is a buy order, said buy order is treated by the processor like a market order when sorting orders,
wherein, when a received order indicates a lower price limit and an upper price limit where the lower price limit is zero and where the order is a sell order, said sell order is treated by the processor like a market order when sorting orders,
wherein, when a received order indicates a lower price limit and an upper price limit where the upper price limit is finite and where the order is a buy order, said buy order is treated by the processor like a limit order when sorting orders, and
wherein, when a received order indicates a lower price limit and an upper price limit where the lower price limit above zero and where the order is a sell order, said sell order is treated by the processor like a limit order when sorting orders.

11. The computer system as recited in claim 7 wherein the processor is further configured to calculate at least one cumulated volume vector indicating a cumulated buy and/or sell volume of one or more orders depending on the execution price.

12. The computer system as recited in claim 11 wherein the processor is configured to allow the highest cumulated buy and/or sell volume of the at least one cumulated volume vector to not correspond to the lowest surplus.

13. The computer system as recited in claim 11 wherein the cumulated buy and/or sell volume in said at least one cumulated volume vector is not weakly monotonically depending on the execution price.

14. The computer system as recited in claim 11 wherein the processor is further configured to perform a price determination process comprising an act of finding the highest executable volume and an act of finding the lowest surplus, wherein the act of finding the lowest surplus is performed only if the act of finding the highest executable volume does not allow to determine the call auction price.

15. The computer system as recited in claim 11 wherein the processor is further configured to perform a price determination process comprising rounding up the call auction price.

16. A computer-implemented method for a derivatives trader trading at an electronic exchange to reduce the risk of having incorrect inventory in an underlying, comprising:
a computer processor of the electronic exchange writing data into a data storage memory of a computer system of the electronic exchange representing an order book, the data indicating characteristics of an order to buy or sell the underlying, said characteristics comprising a minimum buy price or a maximum sell price.

17. The computer-implemented method as recited in claim 16 wherein the order is a single stock order with physical delivery, and the data is stored in the order book on the settlement day of an option having this stock as underlier.

18. The computer-implemented method as recited in claim 16 wherein said characteristics further comprise a maximum buy price or a minimum sell price.

19. The computer-implemented method as recited in claim 16, wherein said computer processor is part of a front-end computing device that is in communication with said computer system, wherein said data is derived from order data transmitted from the front-end computing device to said computer system.

20. The computer-implemented method as recited in claim 16, wherein said computer processor is part of said computer system being in communication with a front-end computing device, wherein said data is derived from order data received from the front-end computing device.
